(19) United States
(12) Patent Application Publication
(10) Pub. No.: US 2026/0233673 A1
(43) Pub. Date: Aug. 13, 2026

(54) VEHICLE VISUAL RECOGNITION DEVICE

(71) Applicant: KABUSHIKI KAISHA TOKAI-RIKA-DENKI-SEISAKUSHO, Niwa-gun, Aichi (JP)

(72) Inventors: Toshiya ITO, Niwa-gun, Aichi (JP); Kazuyuki YOKOYAMA, Niwa-gun, Aichi (JP)

(21) Appl. No.: 19/153,739

(22) PCT Filed: Jan. 22, 2024
(86) PCT No.: PCT/JP2024/001635

§ 371 Date: Aug. 5, 2025

(30) Foreign Application Priority Data
Feb. 6, 2023 (JP) 2023-016453

(51) Int. Cl. B60R 1/07

(52) U.S. Cl. CPC B60R 1/07

(57) ABSTRACT

In a vehicle camera device, separation of a restriction protrusion of a final gear from a restriction hole of a clutch is permitted against biasing force of a spring, and rotation of the final gear is permitted, whereby a case body is rotated, and a sliding cylinder of the case body is slid with respect to a sliding surface of a stand. Here, the clutch and the spring are disposed inside the sliding surface. Thus, the vehicle camera device can be downsized in a rotation axis direction of the case body.

### TECHNICAL FIELD

The present invention relates to a vehicle visual recognition device in which a visual recognition mechanism is rotated by a rotating body being rotated.

### BACKGROUND ART

In a door mirror device for a vehicle described in Japanese Patent Application Laid-Open (JP-A) No. 2002-274268, a mirror is rotated by a case member being slid and rotated with respect to a sliding surface of a support shaft. Further, a clutch plate restricts rotation of the case member by biasing force of a compression coil spring, and the clutch plate allows rotation of the case member against the biasing force of the compression coil spring.

Here, in the door mirror device for the vehicle, the clutch plate and the compression coil spring are disposed above the sliding surface of the support shaft.

### SUMMARY OF INVENTION

### Technical Problem

In consideration of the above fact, an object of the present invention is to obtain a vehicle visual recognition device that can be downsized in a rotation axis direction of a rotating body.

### Solution to Problem

A vehicle visual recognition device according to a first aspect of the present invention includes a visual recognition mechanism that assists visual recognition of an occupant of a vehicle, a sliding body provided on a side of a vehicle body and provided with a sliding surface, a rotating body that is rotated by being slid with respect to the sliding surface, whereby the visual recognition mechanism is rotated, a restriction member disposed inside the sliding surface, and a biasing member disposed inside the sliding surface, causing the restriction member to restrict rotation of the rotating body by biasing force, and causing the restriction member to allow rotation of the rotating body against the biasing force.

A vehicle visual recognition device according to a second aspect of the present invention is the vehicle visual recognition device according to the first aspect of the present invention, including an action member which is supported by the sliding surface and to which driving force is applied to rotate the rotating body.

A vehicle visual recognition device according to a third aspect of the present invention is the vehicle visual recognition device according to the first aspect or the second aspect of the present invention, including a fixing portion that is provided at the sliding body further inside than the sliding surface and that is fixed to the side of the vehicle body, whereby the sliding body is fixed to the side of the vehicle body.

A vehicle visual recognition device according to a fourth aspect of the present invention is the vehicle visual recognition device according to any one of the first to third aspects of the present invention, including a locking portion which is provided at the sliding body further inside than the sliding surface, and to which the biasing member is locked.

A vehicle visual recognition device according to a fifth aspect of the present invention is the vehicle visual recognition device according to any one of the first to fourth aspects of the present invention, including an inclined surface that is provided at at least one of the sliding body or the side of the vehicle body and that restricts movement of the sliding body.

### Advantageous Effects of Invention

In the vehicle visual recognition device according to the first aspect of the present invention, the visual recognition mechanism assists visual recognition of the occupant of the vehicle. In addition, the visual recognition mechanism is rotated by the rotating body being slid with respect to the sliding surface of the sliding body at the side of the vehicle body and rotated. Further, the restriction member restricts rotation of the rotating body by the biasing force of the biasing member, and the restriction member allows the rotation of the rotating body against the biasing force of the biasing member.

Here, the restriction member and the biasing member are disposed inside the sliding surface of the sliding body. Thus, the vehicle visual recognition device can be downsized in a rotation axis direction of the rotating body.

In the vehicle visual recognition device according to the second aspect of the present invention, the action member is supported on the sliding surface, and the driving force is applied to the action member to rotate the rotating body. Thus, the rotating body can be rotated by the driving force.

In the vehicle visual recognition device according to the third aspect of the present invention, the sliding body includes a fixing portion that is provided at a position further inside than the sliding surface, the fixing portion is fixed to the side of the vehicle body, whereby the sliding body is fixed to the side of the vehicle body. Thus, the sliding body can be fixed to the side of the vehicle body.

In the vehicle visual recognition device according to the fourth aspect of the present invention, the sliding body includes the locking portion that is provided at a position further inside than the sliding surface, and the biasing member is locked to the locking portion. Thus, the biasing member can be locked.

In the vehicle visual recognition device according to the fifth aspect of the present invention, the inclined surface is provided at at least one of the sliding body or the side of the vehicle body, and movement of the sliding body is restricted by the inclined surface. Thus, the movement of the sliding body can be restricted.

### BRIEF DESCRIPTION OF DRAWINGS

FIG. 1 is an exploded perspective view illustrating a vehicle camera device according to an embodiment of the present invention as viewed from a vehicle rear side and an outside in a vehicle width direction.

FIG. 2 is a top view illustrating an inside of the vehicle camera device according to the embodiment of the present invention.

FIG. 3 is a top view illustrating an inside of a storage mechanism of the vehicle camera device according to the embodiment of the present invention.

FIG. 4A is a view illustrating the storage mechanism of the vehicle camera device according to the embodiment of the present invention, and is a cross-sectional view (cross-sectional view taken along a line 4A-4A in FIG. 3) as viewed from the front side.

FIG. 4B is a view illustrating the storage mechanism of the vehicle camera device according to the embodiment of the present invention, and is a cross-sectional view (cross-sectional view taken along a line 4B-4B in FIG. 3) as viewed from the outside in the vehicle width direction.

FIG. 5 is an exploded perspective view illustrating the storage mechanism of the vehicle camera device according to the embodiment of the present invention as viewed from the vehicle front side and an inside in the vehicle width direction.

FIG. 6A is a side view of a stand of the vehicle camera device according to the embodiment of the present invention.

FIG. 6B is a bottom view of the stand of the vehicle camera device according to the embodiment of the present invention.

FIG. 6C is a cross-sectional view (cross-sectional view taken along a line 6C-6C in FIG. 6B) illustrating a fixed situation of the stand of the vehicle camera device according to the embodiment of the present invention.

FIG. 6D is a cross-sectional view (cross-sectional view taken along a line 6D-6D in FIG. 6B) illustrating a fixed situation of the stand of the vehicle camera device according to the embodiment of the present invention.

FIG. 7A is a top view of a clutch of the vehicle camera device according to the embodiment of the present invention.

FIG. 7B is a side view of the clutch of the vehicle camera device according to the embodiment of the present invention.

FIG. 7C is a cross-sectional view (cross-sectional view taken along a line 7C-7C in FIG. 7A) of the clutch of the vehicle camera device according to the embodiment of the present invention.

### DESCRIPTION OF EMBODIMENTS

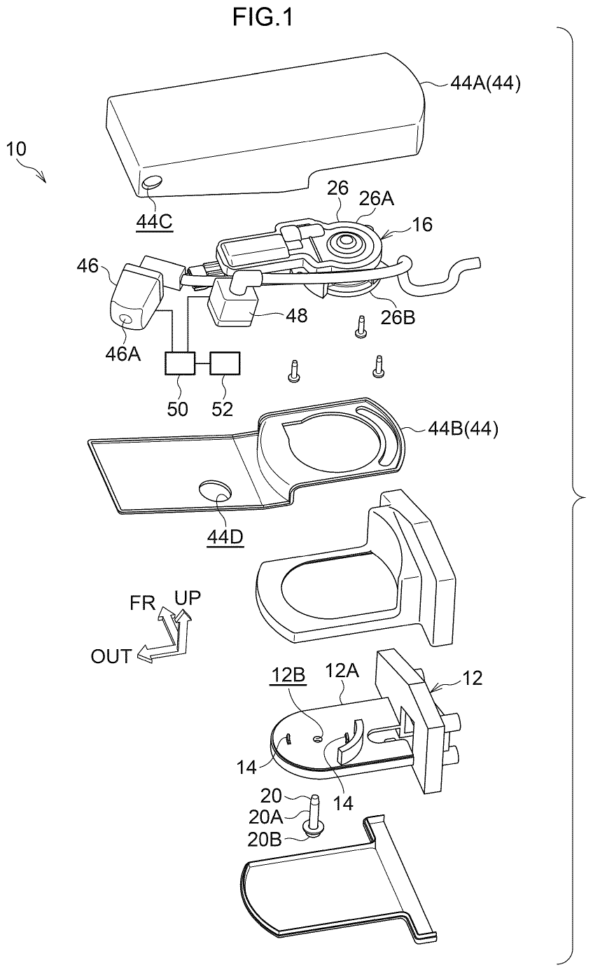

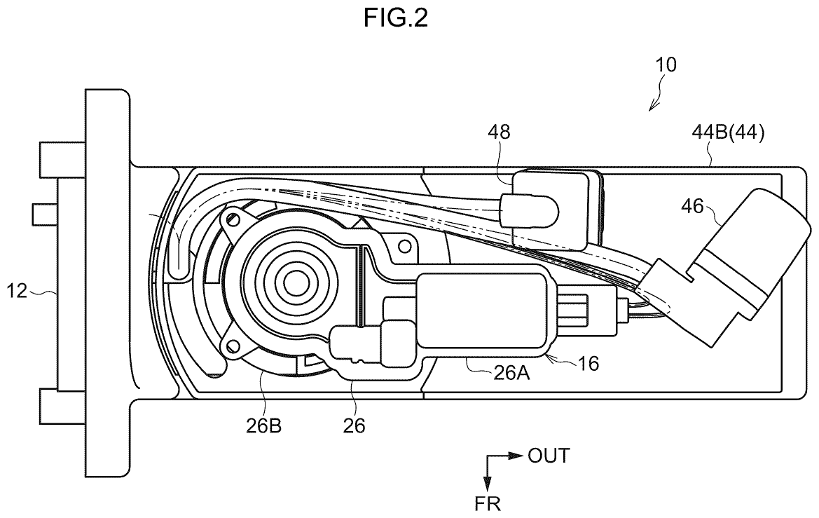

FIG. 1 is an exploded perspective view of a vehicle camera device 10 as a vehicle visual recognition device according to an embodiment of the present invention as viewed from a vehicle rear side and an outside in a vehicle width direction (vehicle left side), and FIG. 2 is a top view of an inside of the vehicle camera device 10. Note that in the drawings, the front side of the vehicle is indicated by an arrow FR, the outside in the vehicle width direction (vehicle left side) is indicated by an arrow OUT, and the upper side is indicated by an arrow UP.

The vehicle camera device 10 according to the present embodiment is provided at a vertically intermediate portion of a side door (particularly, a front side door) as a door of the vehicle, at a vehicle front side end, and is disposed outside the vehicle.

As illustrated in FIGS. 1 and 2, the vehicle camera device 10 includes a base 12 provided at a side of a vehicle body, serving as an installation member, and the vehicle camera device 10 is installed on the side door by an inner end portion of the base 12 in the vehicle width direction being fixed to the side door. The base 12 is provided with a base plate 12A having a substantially rectangular plate shape, and the base plate 12A protrudes outward in the vehicle width direction. The base plate 12A is arranged vertically in a vertical direction, and a circular fixing hole 12B is formed to penetrate the base plate 12A.

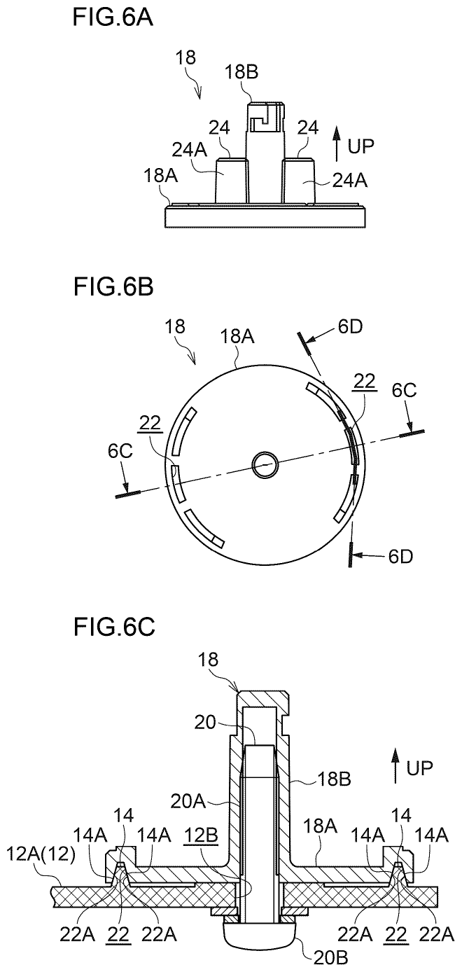

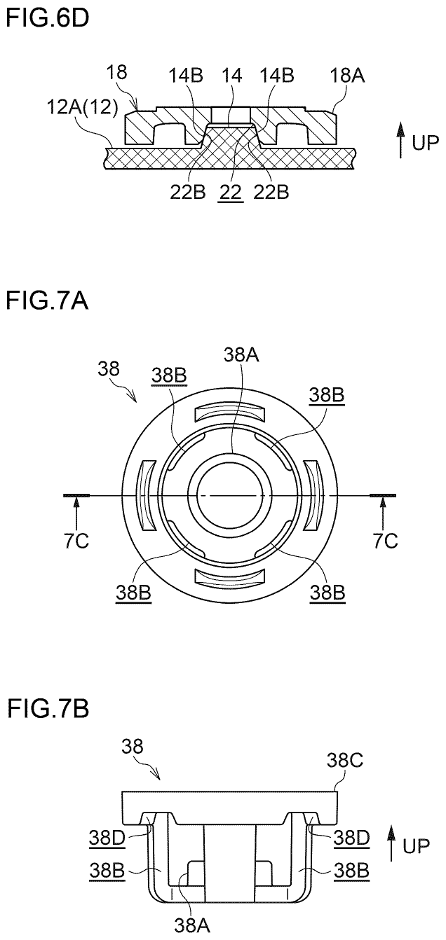

The base plate 12A is integrally provided with a plurality of (two in the present embodiment) trapezoidal columnar restriction protrusions 14 (see FIGS. 6C and 6D) as restriction portions on a radially outer side of the fixing hole 12B, and the restriction protrusions 14 protrude upward. The restriction protrusions 14 extend along a circumferential direction of the fixing hole 12B, and the plurality of restriction protrusions 14 is arranged at equal intervals in the circumferential direction of the fixing hole 12B. An outer peripheral side surface and an inner peripheral side surface of the restriction protrusion 14 are formed as first laterally inclined surfaces 14A as inclined surfaces, and the first laterally inclined surfaces 14A are inclined inward in a width direction of the restriction protrusion 14 as they go upward. End surfaces on both sides in an extending direction of the restriction protrusion 14 are formed as first end inclined surfaces 14B as inclined surfaces, and the first end inclined surfaces 14B are inclined inward in the extending direction of the restriction protrusion 14 as they go upward.

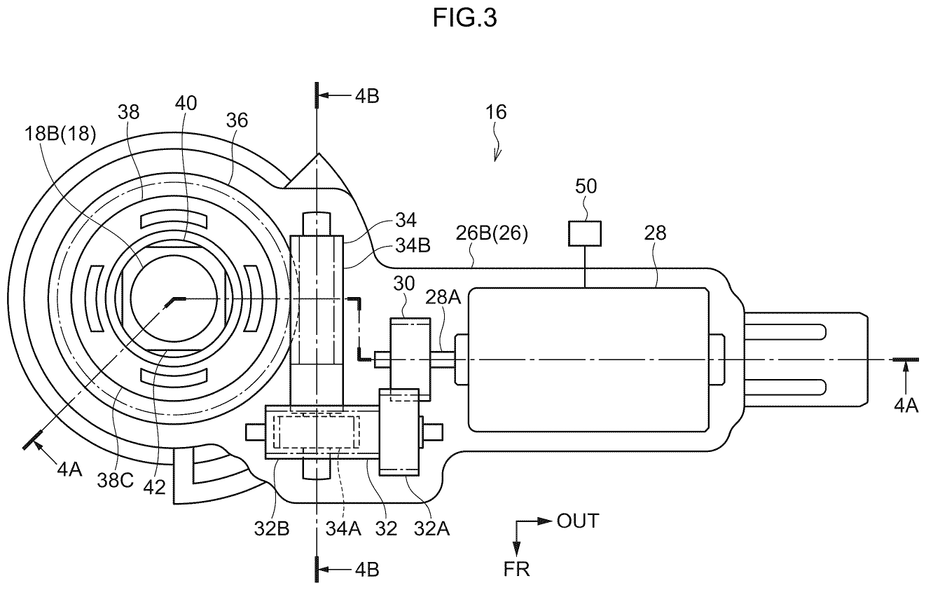

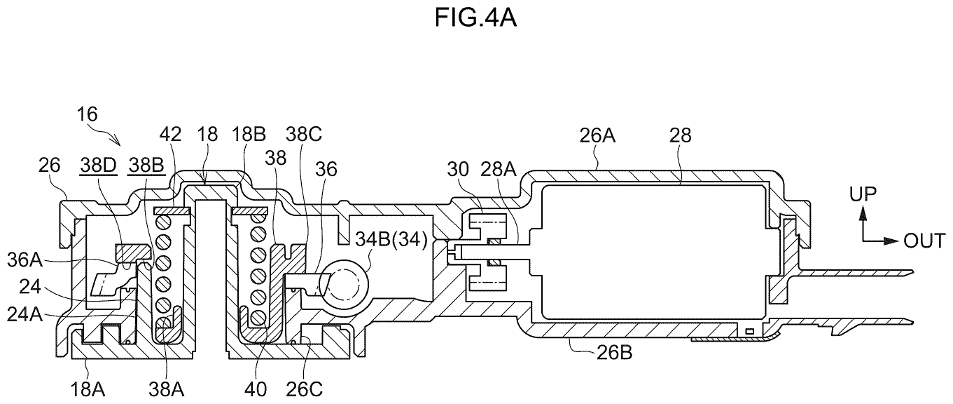

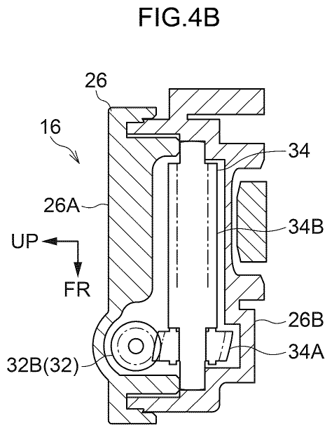

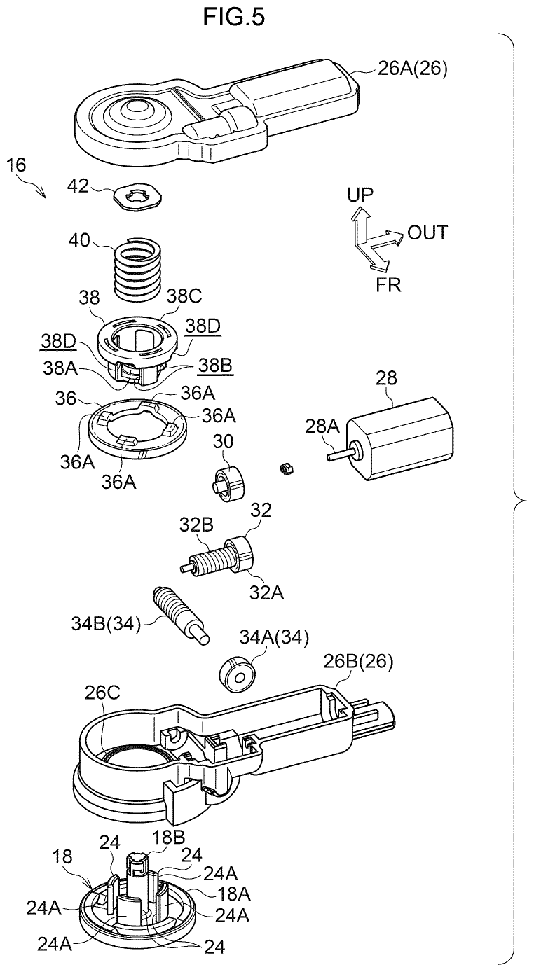

A storage mechanism 16 (see retractor, FIGS. 3, 4A, 4B, and 5) is supported above the base plate 12A of the base 12.

The storage mechanism 16 is provided with a stand 18 (see FIGS. 6A to 6D) as a sliding body (support). A substantially disk-shaped substrate 18A is provided at a lower end portion of the stand 18, and the substrate 18A is vertically disposed in the vertical direction.

A fixing cylinder 18B having a substantially bottomed cylindrical shape as a fixing portion and a locking portion is coaxially and integrally provided at a central portion of the substrate 18A, and the fixing cylinder 18B extends upward and has an inside opened below the substrate 18A. A leg portion 20A (screw portion) of a fixing screw 20 as a fixing member is screwed into the fixing cylinder 18B from below, and the leg portion 20A of the fixing screw 20 penetrates the fixing hole 12B of the base 12 (base plate 12A) from below. The base plate 12A is sandwiched between the substrate 18A and a head 20B of the fixing screw 20, whereby the stand 18 is fixed (fastened) to the base plate 12A, and the storage mechanism 16 is supported by the base plate 12A.

On the substrate 18A, a plurality of (two in the present embodiment) trapezoidal columnar restriction holes 22 as restricted portions is formed on the radially outer side of the fixing cylinder 18B, and the restriction holes 22 are opened downward. The restriction holes 22 extend along the circumferential direction of the substrate 18A, and the plurality of restriction holes 22 is arranged at equal intervals in the circumferential direction of the substrate 18A. An outer peripheral side surface and an inner peripheral side surface of the restriction hole 22 are formed as second laterally inclined surfaces 22A as inclined surfaces, and the second laterally inclined surfaces 22A are inclined inward in the width direction of the restriction hole 22 as they go upward. End surfaces on both sides in the extending direction of the restriction hole 22 are formed as second end inclined surfaces 22B as inclined surfaces, and the second end inclined surfaces 22B are inclined inward in the extending direction of the restriction hole 22 as they go upward.

A restriction projection 14 of the base 12 (base plate 12A) is inserted into the restriction hole 22. The pair of second laterally inclined surfaces 22A is fitted to the pair of first laterally inclined surfaces 14A of the restriction protrusion 14, whereby movement of the restriction hole 22 in the radial direction of the substrate 18A is restricted, and movement of the substrate 18A in the radial direction is restricted. The pair of second end inclined surfaces 22B is fitted to the pair of first end inclined surfaces 14B of the restriction protrusion 14, whereby movement of the restriction hole 22 in the circumferential direction of the substrate 18A is restricted, and movement of the substrate 18A in the circumferential direction is restricted.

On the substrate 18A, a plurality of (four in the present embodiment) sliding plates 24 each having a substantially rectangular plate shape as sliding portions (support portions) is integrally provided on the radially outer side of the fixing cylinder 18B, and the sliding plates 24 extend upward. The sliding plates 24 are curved along the circumferential direction of the substrate 18A, and the plurality of sliding plates 24 is arranged at equal intervals in the circumferential direction of the substrate 18A. Outer peripheral surfaces of the sliding plates 24 are sliding surfaces 24A (support surfaces).

A case body 26 having a substantially rectangular parallelepiped box shape as a rotating body is supported on the stand 18, and the case body 26 is configured by assembling a lower case 26A and an upper cover 26B in the vertical direction. A cylindrical sliding cylinder 26C as a sliding portion (supported portion) is formed on a lower wall of an inner portion in the vehicle width direction of the case body 26 (case 26A), and the sliding cylinder 26C protrudes to both sides in a vertical direction that is the axial direction, of the lower wall of the case body 26. The sliding cylinder 26C opens the inside of the case body 26 downward, and the fixing cylinder 18B of the stand 18 and the sliding plate 24 are inserted into the sliding cylinder 26C from the lower side. A plurality of sliding plates 24 (sliding surfaces 24A) is fitted in the sliding cylinder 26C, whereby the sliding cylinder 26C is rotatably supported by the plurality of sliding plates 24, and the case body 26 is rotatably supported by the plurality of sliding plates 24.

A motor 28 as a drive mechanism is fixed in an outer portion of the case body 26 in the vehicle width direction, and an output shaft 28A of the motor 28 extends inward in the vehicle width direction. An initial gear 30 (spur gear) is coaxially supported on the output shaft 28A, and the initial gear 30 is integrally rotated with the output shaft 28A.

A twin gear 32 as a first gear is supported in an intermediate portion in the vehicle width direction of the case body 26, and an axial direction of the twin gear 32 is made the vehicle width direction. A spur gear 32A is coaxially provided in an outer portion in the vehicle width direction of the twin gear 32, and the spur gear 32A meshes with the initial gear 30. A first worm 32B is coaxially provided in an inner portion in the vehicle width direction of the twin gear 32, and the first worm 32B is integrally rotated with the spur gear 32A.

A drive gear 34 as a second gear is supported in an intermediate portion in the vehicle width direction of the case body 26, and an axial direction of the drive gear 34 is made a vehicle front-rear direction. A helical gear 34A (worm wheel) is coaxially provided on a vehicle front side portion of the drive gear 34, and the helical gear 34A meshes with the first worm 32B. A second worm 34B is coaxially provided on a vehicle rear side portion of the drive gear 34, and the second worm 34B is integrally rotated with the helical gear 34A.

A final gear 36 (worm wheel) having an annular disk shape, as an action member is disposed in an inner portion in the vehicle width direction of the case body 26, and the final gear 36 meshes with the second worm 34B. The fixing cylinder 18B of the stand 18 and the sliding plate 24 are inserted into the final gear 36 from the lower side, and the final gear 36 is supported by the sliding cylinder 26C of the case body 26 from the lower side. A plurality of sliding plates 24 is fitted in the final gear 36, whereby the final gear 36 is rotatably supported by the plurality of sliding plates 24.

On an upper surface of the final gear 36, a plurality of (four in the present embodiment) restriction protrusions 36A having a substantially rectangular plate shape as restricted portions is integrally provided, and the restriction protrusions 36A protrude upward. The restriction protrusions 36A extend along the circumferential direction of the final gear 36, and the plurality of restriction protrusions 36A is arranged at equal intervals in the circumferential direction of the final gear 36. Further, end surfaces on both sides in the extending direction of the restriction protrusion 36A are inclined inward in the extending direction of the restriction protrusion 36A as they go upward.

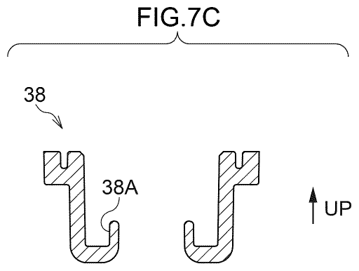

A substantially bottomed cylindrical clutch 38 (see FIGS. 7A to 7C) as a restriction member is coaxially provided inside the final gear 36, and an inside of the clutch 38 is opened upward. A cylindrical fitting cylinder 38A is coaxially and integrally provided on a lower wall (bottom wall) of the clutch 38, and the fitting cylinder 38A protrudes upward. An inside of the fitting cylinder 38A is opened downward, and the fixing cylinder 18B of the stand 18 is fitted into the fitting cylinder 38A from the lower side.

A plurality of (four in the present embodiment) substantially rectangular blocking holes 38B as blocked portions is formed to penetrate a peripheral wall of the clutch 38, and the plurality of blocking holes 38B is arranged at equal intervals in the circumferential direction of the clutch 38. The sliding plate 24 of the stand 18 is inserted into the blocking hole 38B from the lower side, and the blocking hole 38B is fitted to the sliding plate 24 in the circumferential direction of the clutch 38 to block movement of the clutch 38 in the circumferential direction.

An annular restriction frame 38C is coaxially and integrally provided at an upper end of the clutch 38, and the restriction frame 38C protrudes radially outward of the clutch 38 and has a substantially rectangular cross section. On a lower surface of the restriction frame 38C, a plurality of (four in the present embodiment) restriction holes 38D having a rectangular cross section as the restricted portions is formed, and the restriction holes 38D are opened downward. The restriction holes 38D extend in the circumferential direction of the restriction frame 38C, and the plurality of restriction holes 38D is arranged at equal intervals in the circumferential direction of the restriction frame 38C. End surfaces on both sides in the extending direction of the restriction hole 38D are inclined inward in the extending direction of the restriction hole 38D as they go upward, and the restriction protrusion 36A of the final gear 36 is inserted into the restriction hole 38D and fitted in the circumferential direction of the final gear 36. Further, the restriction protrusion 36A and the restriction frame 38C are disposed radially outside the sliding plate 24 of the stand 18.

A spring 40 (coil spring) as a biasing member is coaxially provided inside the clutch 38, and the fixing cylinder 18B of the stand 18 and the fitting cylinder 38A of the clutch 38 are coaxially inserted inside the spring 40, and a lower end of the spring 40 abuts on (is locked to) the lower wall of the clutch 38. An upper end of the fixing cylinder 18B is coaxially inserted into a cam plate 42 having a substantially annular disk shape, as a locking member, and upward movement of the cam plate 42 is locked by the upper end of the fixing cylinder 18B. An upper end of the spring 40 is in contact (locked) with the cam plate 42 from the lower side, and the spring 40 is compressed in the vertical direction (axial direction). The spring 40 biases the lower wall of the clutch 38 downward, whereby separation of the restriction protrusion 36A of the final gear 36 from the restriction hole 38D of the clutch 38 (restriction frame 38C) is restricted, and rotation of the final gear 36 is restricted.

The case body 26 is fixed in a visor 44 having a substantially rectangular parallelepiped box shape as a covering body, and the visor 44 covers an outer periphery of the case body 26.

The visor 44 is configured such that an upper visor 44A on an upper side and a lower visor 44B on a lower side are assembled in the vertical direction, and the substrate 18A of the stand 18 penetrates an inner portion of a lower wall of the visor 44 (lower visor 44B) in the vehicle width direction. A circular rear hole 44C is formed through an outer end in the vehicle width direction of a vehicle rear side wall of the visor 44 (upper visor 44A), and a circular lower hole 44D is formed through an intermediate portion in the vehicle width direction of a lower wall of the visor 44 (lower visor 44B).

A rear camera 46 as a visual recognition mechanism is fixed to an outer end in the vehicle width direction in the visor 44, and a lens 46A of the rear camera 46 is exposed to an outside of the visor 44 from the rear hole 44C of the visor 44 and directed to the rear side of the vehicle. A lower camera 48 as a visual recognition mechanism is fixed to an intermediate portion in the vehicle width direction in the visor 44, and a lens (not illustrated) of the lower camera 48 is exposed to the outside of the visor 44 from the lower hole 44D of the visor 44 and directed downward.

The rear camera 46 and the lower camera 48 are electrically connected to the control device 50 of the vehicle. Under the control of the control device 50, the rear camera 46 images the vehicle rear side of the visor 44 via the rear hole 44C of the visor 44 and the lens 46A. In addition, under the control of the control device 50, the lower camera 48 images the lower side of the visor 44 via the lower hole 44D of the visor 44 and the lens. A monitor 52 as a display mechanism is electrically connected to the control device 50, and the monitor 52 displays the images captured by the rear camera 46 and the lower camera 48 under the control of the control device 50. The monitor 52 is installed in the vehicle interior, and by an occupant (particularly a driver) of the vehicle viewing the images displayed on the monitor 52, the image captured by the rear camera 46 assists the occupant in viewing the rear side of the vehicle, and the image captured by the lower camera 48 assists the occupant in viewing the lower side. Further, the motor 28 of the storage mechanism 16 is electrically connected to the control device 50 (see FIG. 3).

Next, operation of the present embodiment will be described.

In the vehicle camera device 10 having the above configuration, in the storage mechanism 16, when the motor 28 is driven by the control of the control device 50, the output shaft 28A, the initial gear 30, the twin gear 32 (the spur gear 32A and the first worm 32B), and the drive gear 34 (the helical gear 34A and the second worm 34B) are rotated, and the drive force of the motor 28 is applied to the final gear 36, so that the drive gear 34 is rotated around the final gear 36, and the case body 26 is rotated around the plurality of sliding plates 24 of the stand 18 integrally with the drive gear 34. Thus, the visor 44 (including the rear camera 46 and the lower camera 48) is rotated integrally with the case body 26 to the vehicle rear side and inward in the vehicle width direction, and the visor 44 is stored. Furthermore, the visor 44 is rotated integrally with the case body 26 outward in the vehicle width direction and to the vehicle front side, whereby the visor 44 stands (returns).

In addition, when load equal to or greater than predetermined load acts on the visor 44 toward the vehicle front side or the vehicle rear side, in the storage mechanism 16, the restriction protrusion 36A of the final gear 36 is permitted to be disengaged from the restriction hole 38D of the clutch 38 (restriction frame 38C) against the biasing force of the spring 40, and the rotation of the final gear 36 is permitted. Thus, the case body 26 is rotated around the plurality of sliding plates 24 integrally with the rotation of the final gear 36, and the visor 44 (including the rear camera 46 and the lower camera 48) is rotated to the vehicle front side or the vehicle rear side integrally with the case body 26.

When the case body 26 is rotated around the plurality of sliding plates 24, an inner peripheral surface of the sliding cylinder 26C of the case body 26 is slid with respect to the sliding surfaces 24A of the plurality of sliding plates 24.

Here, the clutch 38 and the spring 40 are disposed on the inner side (inner peripheral side) of the plurality of sliding surfaces 24A. Thus, unlike with a case where the clutch 38 and the spring 40 are disposed above the plurality of sliding surfaces 24A, the storage mechanism 16 can be downsized in the vertical direction (the rotation axis direction of the case body 26), and the vehicle camera device 10 can be downsized. As a result, mountability of the storage mechanism 16 in the visor 44 can be improved, and design of the vehicle camera device 10 can be reduced in size and thickness. In addition, air resistance of the vehicle camera device 10 can be reduced when the vehicle travels, which can improve fuel efficiency of the vehicle, and the vehicle camera device 10 can be prevented from hindering visual recognition of the outside of the vehicle by the occupant, which can expand a visual recognition range of the outside of the vehicle by the occupant.

Further, the case body 26 is supported by the plurality of sliding surfaces 24A. It is therefore possible to suppress rattling of the case body 26 and suppress rattling of the visor 44 (including the rear camera 46 and the lower camera 48).

Further, the final gear 36 is supported by the plurality of sliding surfaces 24A. It is therefore possible to suppress rattling of the final gear 36, favorably rotate the drive gear 34 around the final gear 36, and favorably rotate the final gear 36.

Furthermore, the stand 18 is provided with the fixing cylinder 18B at a position further inside than the plurality of sliding surfaces 24A, and the upper end of the spring 40 is locked to the fixing cylinder 18B via the cam plate 42. Thus, even in a case where the spring 40 is disposed inside the plurality of sliding surfaces 24A, the upper end of the spring 40 can be favorably locked.

The fixing cylinder 18B of the stand 18 is fixed to the base plate 12A of the base 12 by the fixing screw 20, whereby the stand 18 is fixed to the base 12. Thus, unlike with a case where the substrate 18A of the stand 18 is fixed to the base plate 12A of the base 12 by the fixing screw 20, the dimension of the substrate 18A in the vertical direction can be reduced, the storage mechanism 16 can be further downsized in the vertical direction, and the vehicle camera device 10 can be further downsized.

Further, the restriction projection 14 of the base 12 (base plate 12A) is inserted into the restriction hole 22 of the stand 18 (substrate 18A), the pair of second laterally inclined surfaces 22A of the restriction hole 22 is fitted to the pair of first laterally inclined surfaces 14A of the restriction projection 14 to restrict movement of the substrate 18A in the radial direction, and the pair of second end inclined surfaces 22B of the restriction hole 22 is fitted to the pair of first end inclined surfaces 14B of the restriction projection 14 to restrict movement of the substrate 18A in the circumferential direction. It is therefore possible to suppress loosening of the fixing screw 20 for fixing the stand 18 to the base plate 12A by suppressing rattling of the stand 18 against the base 12 due to vibration of the vehicle and impact on the stand 18.

Note that in the present embodiment, the clutch 38 is made non-rotatable with respect to the stand 18, and the clutch 38 restricts rotation of the final gear 36 by the biasing force of the spring 40. However, the clutch 38 may be made rotatable with respect to the stand 18, and the stand 18 may restrict rotation of the clutch 38 by the biasing force of the spring 40. In this case, the final gear 36 may be integrally rotatable with the clutch 38.

Further, in the present embodiment, the biasing member is a coil spring that is the spring 40. However, a plurality of disc springs may be stacked to form the biasing member, or the biasing member may be a wave spring.

Furthermore, in the present embodiment, the base 12 is provided with inclined surfaces (the first laterally inclined surface 14A and the first end inclined surface 14B), and the stand 18 is provided with inclined surfaces (the second laterally inclined surface 22A and the second end inclined surface 22B). However, one of the base 12 and the stand 18 may be provided with an inclined surface.

Further, in the present embodiment, the visual recognition mechanism is a camera (the rear camera 46 and the lower camera 48). However, the visual recognition mechanism may be a mirror.

The disclosure of Japanese Patent Application No. 2023-16453 filed on Feb. 6, 2023 is incorporated herein by reference in its entirety.

1. A vehicle visual recognition device, comprising:
a visual recognition mechanism that assists visual recognition of an occupant of a vehicle;
a sliding body provided at a side of a vehicle body and provided with a sliding surface;
a rotating body that is rotated by being slid with respect to the sliding surface, whereby the visual recognition mechanism is rotated;
a restriction member disposed inside the sliding surface; and
a biasing member disposed inside the sliding surface, causing the restriction member to restrict rotation of the rotating body by biasing force, and causing the restriction member to allow rotation of the rotating body against the biasing force.

2. The vehicle visual recognition device according to claim 1, further comprising an action member which is supported by the sliding surface and to which driving force is applied to rotate the rotating body.

3. The vehicle visual recognition device according to claim 1, further comprising a fixing portion that is provided at the sliding body further inside than the sliding surface and that is fixed to the side of the vehicle body, whereby the sliding body is fixed to the side of the vehicle body.

4. The vehicle visual recognition device according to claim 1, further comprising a locking portion which is provided at the sliding body further inside than the sliding surface, and to which the biasing member is locked.

5. The vehicle visual recognition device according to claim 1, further comprising an inclined surface that is provided at at least one of the sliding body or the side of the vehicle body and that restricts movement of the sliding body.
